(19) United States
(12) Patent Application Publication
(10) Pub. No.: US 2008/0266350 A1
(43) Pub. Date: Oct. 30, 2008

(54) APPARATUS TO PRINT PRINTING PATTERNS USING INKJET TECHNIQUE AND METHOD THEREOF

(75) Inventor: Jong-beom KIM, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/859,932

(22) Filed: Sep. 24, 2007

(30) Foreign Application Priority Data
Apr. 24, 2007 (KR) 2007-40041

(51) Int. Cl. B41J 2/165

(52) U.S. Cl. 347/28

(57) ABSTRACT

An apparatus to print printing patterns using an inkjet technique and a method thereof. The apparatus includes an inkjet head to eject ink on a substrate to form the printing patterns, and a solvent coating unit disposed on at least one side of the inkjet head to uniformize a solvent atmosphere formed around the printing patterns during a drying of the ink. The solvent coating unit coats a solvent layer on the substrate to surround the printing patterns formed on an edge of the substrate.

### CROSS-REFERENCE TO RELATED APPLICATIONS

This application claims priority under 35 U.S.C. §119(a) from Korean Patent Application No. 10-2007-0040041, filed on Apr. 24, 2007, in the Korean Intellectual Property Office, the disclosure of which is incorporated herein in its entirety by reference.

### BACKGROUND OF THE INVENTION

1. Field of the Invention

The present general inventive concept relates to an apparatus to print printing patterns using an inkjet printing technique, and a method thereof.

2. Description of the Related Art

Conventionally, cathode ray tube (CRT) monitors have been used for TV sets and computer monitors. In recent years, however, CRT monitors have been replaced by flat panel displays (FPDs), such as liquid crystal displays (LCDs), plasma display panels (PDPs), organic light emitting diodes (OLEDs), and field emission displays (FEDs). Among the FPDs, the LCDs have attracted considerable attention for use in computer monitors and notebook computers due to their low power consumption.

An LCD includes a color filter that allows white light modulated by a liquid crystal (LC) layer to pass therethrough to create an image in a desired color. The color filter includes a plurality of red (R), green (G), and blue (B) pixels, which are arranged in a predetermined shape on a transparent substrate. Conventionally, the color filter has been fabricated using a variety of methods, for example, a dyeing method, a pigment dispersion method, a printing method, and an electrodeposition method. However, since the conventional methods involve repetitively performing a predetermined process on predetermined pixels, the process efficiency is low and the fabrication costs are high.

In order to overcome these drawbacks, a method of fabricating a color filter using an inkjet printing technique, which can simplify the entire fabrication process and reduce the fabrication costs, has been proposed lately. The method includes filling pixels defined on a transparent substrate by a black matrix with liquid ink by ejecting droplets of ink of a predetermined color, for example, droplets of R, G, and B ink, through nozzles of an inkjet head and drying the liquid ink.

However, when fabricating the color filter using the above inkjet printing technique, a solvent atmosphere formed around pixels located on an edge of the color filter becomes different from a solvent atmosphere formed around pixels located on the center of the color filter during the drying of the liquid ink.

FIG. 1A illustrates liquid ink 30′ filled in a pixel located on an edge of a color filter, and FIG. 1B illustrates an ink layer 30 formed in the pixel after drying the liquid ink 30′. In FIGS. 1A and 1B, reference numeral 10 denotes a transparent substrate, and reference numeral 20 denotes a black matrix used to define a plurality of pixels formed on the transparent substrate.

Referring to FIG. 1A, the liquid ink 30′ is dried while a solvent contained in the liquid ink 30′ filled in the pixel located on the edge of the color filter is evaporating. In this case, since the solvent evaporates quicker on an outside portion of the pixel where a partial pressure of solvent vapors is lower, solid components, such as pigments, which are contained in the liquid ink 30′, move to the outside portion of the pixel. Thus, after drying the liquid ink 30′, an ink layer 30 having a non-uniform thickness is formed in the pixel located on the edge of the color filter as illustrated in FIG. 1B. This results in several problems, such as light leakage or image spots, which affect a quality of a display. Also, these problems may occur when printing patterns are repetitively printed using an inkjet method, for example, when an organic emission layer is formed using an inkjet method during fabrication of an organic light emitting diode (OLED) or when an organic semiconductor layer is formed using an inkjet method during fabrication of an organic thin film transistor (OTFT).

### SUMMARY OF THE INVENTION

The present general inventive concept provides an apparatus to form a uniform ink layer to print printing patterns using an inkjet technique, and a method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to print printing patterns on a substrate using an inkjet technique, the apparatus including an inkjet head to eject ink on the substrate to form the printing patterns, and a solvent coating unit to coat a solvent layer on the substrate to surround the printing patterns formed on an edge of the substrate. The solvent coating unit disposed on at least one side of the inkjet head to uniformize a solvent atmosphere formed around the printing patterns during a drying of the ink.

The solvent layer coated by the solvent coating unit may include a same solvent as a solvent contained in the ink used to form the printing patterns.

The solvent layer formed on the substrate may have a width at least twice a length of the printing pattern. Also, the solvent layer may be coated while the inkjet head is printing the printing patterns on the edge of the substrate.

The solvent coating unit may be installed on at least one side of the inkjet head to be capable of moving vertically. The inkjet head may be one of a piezoelectric inkjet head and a thermal inkjet head.

The foregoing and/or other aspects and utilities of the present general inventive concept may also be achieved by providing a method of printing patterns by ejecting ink on a substrate using an inkjet printing technique. The method includes coating a solvent layer on the substrate to surround printing patterns printed on an edge of the substrate to uniformize a solvent atmosphere formed around the printing patterns during a drying of the ink.

The foregoing and/or other aspects and utilities of the present general inventive concept may also be achieved by providing an apparatus to fabricate a color filter by ejecting ink in pixels formed on a substrate using an inkjet technique. The apparatus includes an inkjet head to eject the ink in the pixels; and a solvent coating unit to coat a solvent layer on the substrate to surround the pixels formed on an edge of the substrate. The solvent coating unit is disposed on at least one side of the inkjet head to uniformize a solvent atmosphere formed around the pixels in which the ink is ejected during a drying of the ink.

The foregoing and/or other aspects and utilities of the present general inventive concept may also be achieved by providing a method of fabricating a color filter by ejecting ink in pixels formed on a substrate using an inkjet printing technique. The method includes coating a solvent layer on the substrate to surround pixels formed on an edge of the substrate to uniformize a solvent atmosphere formed around the pixels in which the ink is ejected during the drying of the ink.

The foregoing and/or other aspects and utilities of the present general inventive concept may also be achieved by providing a printing apparatus usable in color filter fabrication, the printing apparatus including an inkjet printhead to eject ink into a plurality of pixels defined in the color filter, and a solvent coating unit to coat a solvent layer around the color filter.

The solvent layer may surround the color filter such that a solvent atmosphere of the pixels at a periphery of the color filter is substantially uniform to a solvent atmosphere of the pixels at a center of the color filter during drying of the ink.

The solvent layer may include a same solvent as a solvent in the ink.

The solvent layer may have a width at least twice a width of a pixel.

The solvent layer may have a width at least twice a length of a pixel.

The solvent coating unit may be disposed on at least one side of the inkjet printhead, such that the solvent layer is coated during the ink ejection process.

The foregoing and/or other aspects and utilities of the present general inventive concept may also be achieved by providing a method to improve a uniformity of an ink thickness for a inkjet technique, the method including forming an ink pattern by ejecting ink onto a surface, and forming a solvent layer by coating a solvent to surround the ink pattern.

The solvent layer may be formed simultaneously with the forming of the ink pattern.

The solvent layer may include a solvent same as a solvent in the ink.

The solvent in the solvent layer may evaporate simultaneously with the solvent in the ink at a periphery of the ink pattern such that a solvent atmosphere of the pixels at a periphery of the color filter is substantially uniform to a solvent atmosphere of the pixels at a center of the color filter during drying of the ink.

The forming of the ink pattern may include ejecting ink into a plurality of pixels defined in a color filter as the surface, and the forming of the solvent layer may include forming a solvent layer to surround the color filter such that a solvent atmosphere of the pixels at a periphery of the color filter is substantially uniform to a solvent atmosphere of the pixels at a center of the color filter during drying of the ink.

The inkjet technique may be used to fabricate one of an organic light emitting diode and an organic thin film transistor.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A illustrates liquid ink filled in a pixel located on an edge of a color filter;

FIG. 1B illustrates a non-uniform ink layer formed in the pixel after drying the liquid ink illustrated in FIG. 1A;

FIG. 2 is a plan view illustrating a printing apparatus according to an embodiment of the present general inventive concept;

FIG. 3 illustrates a cross-sectional view taken along a line III-III′ of FIG. 2;

FIGS. 4 through 6 are diagrams illustrating a method of fabricating a color filter according to an embodiment of the present general inventive concept;

FIG. 7A illustrates a cross-sectional view taken along a line VII-VII′ of FIG. 6; and

FIG. 7B illustrates a uniform ink layer formed in a pixel after drying liquid ink illustrated in FIG. 7A.

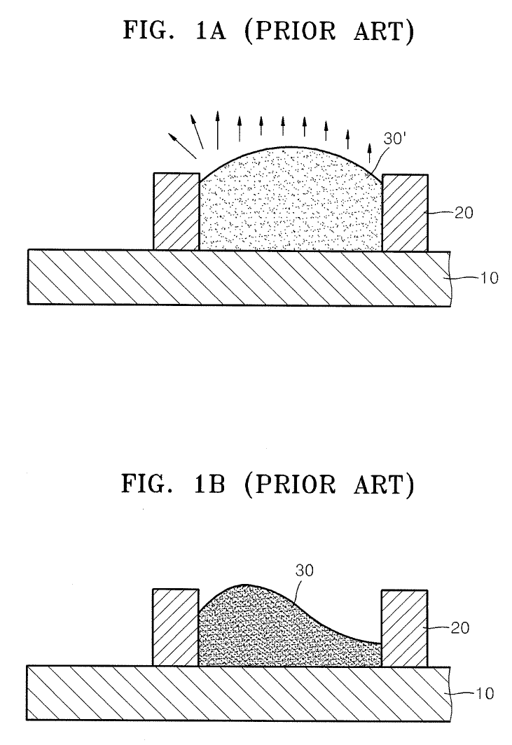

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides an apparatus to repetitively print a printing pattern using an inkjet technique and a method of printing the printing patterns. Hereinafter, for a color filter and a method of fabricating the color filter according to exemplary embodiments of the present general inventive concept will be described.

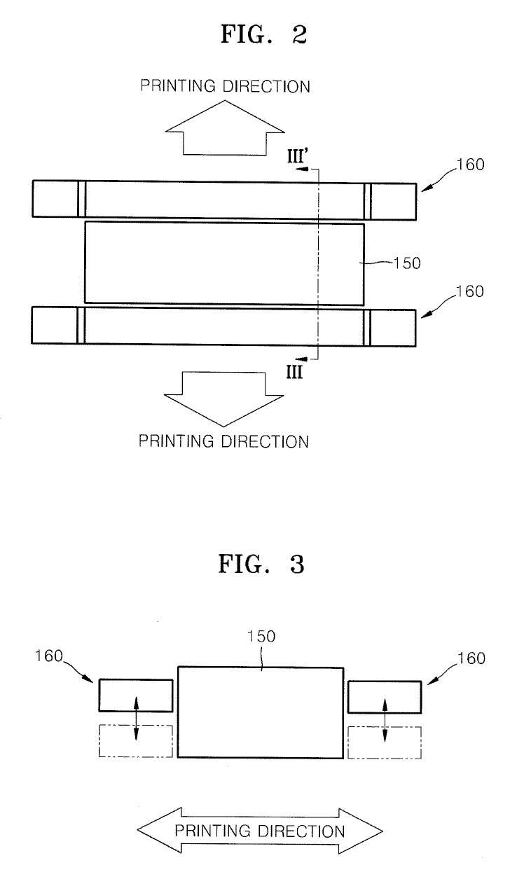

FIG. 2 is a plan view illustrating an printing apparatus to fabricate a color filter according to an embodiment of the present general inventive concept, and FIG. 3 illustrates a cross-sectional view taken along a line III-III′ of FIG. 2.

Referring to FIGS. 2 though 4, a printing apparatus to fabricate a color filter according to an embodiment of the present general inventive concept may include an inkjet head 150 and a solvent coating unit 160 disposed on both sides of the inkjet head 150. The inkjet head 150 repetitively prints predetermined printing patterns by ejecting small droplets of ink of a predetermined color in pixels 125 defined on a substrate 110 by a black matrix 120. The inkjet head 150 may include a plurality of nozzles (not illustrated) through which ink is ejected. The inkjet head 150 may be, for example, a piezoelectric inkjet head or a thermal inkjet head. The piezoelectric inkjet head applies a pressure generated by deforming a piezoelectric material to ink and ejects the ink using the pressure. The thermal inkjet head produces bubbles using a thermal source and ejects ink using an expansive force of the bubbles.

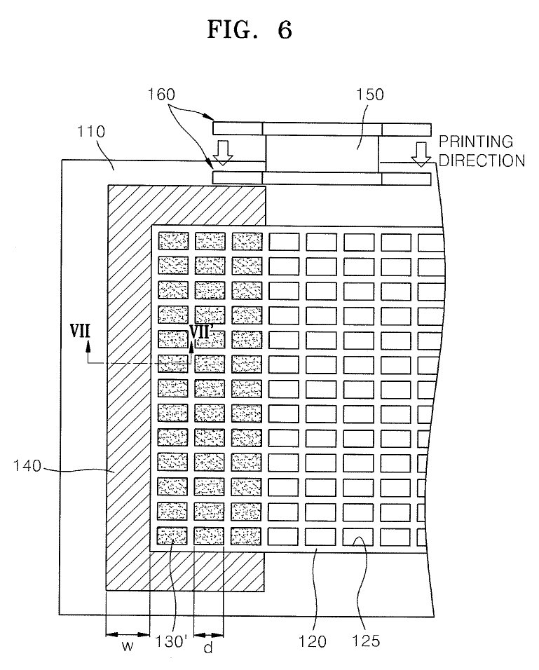

The solvent coating unit 160 is used to uniformize a solvent atmosphere formed around the pixels 125 in which the printing patterns are formed when ink is dried. More specifically, the solvent coating unit 160 is used to equalize a solvent atmosphere formed around the pixels 125 located on an edge of the substrate 110 to a solvent atmosphere formed around the pixels 125 located on the center of the substrate 110. For this, the solvent coating unit 160 moves along with the inkjet head 150 and coats a solvent on the substrate 110 around the printing patterns printed in the pixels 125 located on the edge of the substrate 110. A solvent layer (reference numeral 140 in FIG. 6) formed along an outer portion of the substrate 110 may have a width “w” at least twice a length “d” of the pixel 125, more preferably a width “w” at least ten times the length “d” of the pixel 125 (see FIG. 6).

The solvent coated by the solvent coating unit 160 may be the same as a solvent contained in ink filled in the pixels 125, that is, a solvent contained in the ink ejected by the inkjet head 150. The solvent coating unit 160 may be, for example, a solvent-moistened brush or a blade to which a solvent is supplied. In addition to the brush or blade, various coating devices that can coat a solvent on the substrate 110 to a predetermined width can be employed. As illustrated in FIG. 3, the solvent coating unit 160 may be installed on both sides of the inkjet head 150 and may also be capable of moving up and down. However, the present general inventive concept is not limited thereto.

Although FIGS. 2 and 3 illustrate the solvent coating unit 160 disposed in a vertical direction to a printing direction, the present general inventive concept is not limited thereto. Also, FIGS. 2 and 3 illustrate the solvent coating unit 160 disposed on both sides of the inkjet head 150, but the present general inventive concept is not limited thereto. For instance, the solvent coating unit 160 may be prepared on at least one side of the inkjet head 150.

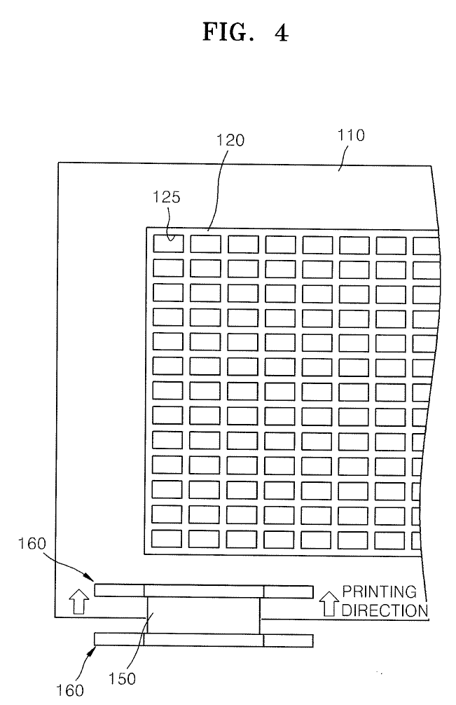

Hereinafter, a method of fabricating a color filter using the above-described apparatus will be described with reference to FIGS. 4 through 6.

Referring to FIG. 4, a black matrix 120 is formed on a substrate 110, and a plurality of pixels 125 are defined on the substrate 110 by the black matrix 120. Also, the apparatus to fabricate a color filter may be initially positioned at an end portion of the substrate 110 to print printing patterns in the pixels 125. The printing apparatus may include an inkjet head 150 and a solvent apparatus 160 prepared on both sides of the inkjet head 150. Since the printing apparatus to fabricate a color filter is described above in detail, a description thereof will be omitted.

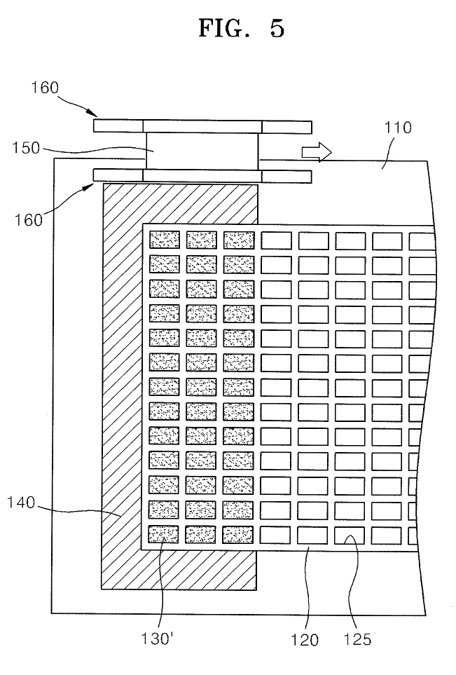

Thereafter, while the apparatus is moving in a printing direction (that is, upward in the drawings), printing patterns are printed in the pixels 125 located on an edge of the substrate 110. While the inkjet head 150 is moving in a printing direction, a predetermined number of droplets of ink are ejected through nozzles (not illustrated) of the inkjet head 150 into the respective pixels 125 so that the printing patterns are formed. Thus, the pixels 125 are filled with liquid ink (reference numeral 130′ in FIG. 5). When the inkjet head 150 prints the printing patterns in the pixels 125 located on the edge of the substrate 110 in a printing direction, the solvent coating unit 160 moves along with the inkjet head 150 and coats a solvent outside the pixels 125 located on the edge of the substrate 110, so that a solvent layer 140 is formed on an outer portion of the substrate 110 as illustrated in FIG. 5. Here, the solvent layer 140 may have a width “w” at least twice the length “d” of the pixel 125, more preferably a width “w” at least ten times the length “d” of the pixel 125. Also, the solvent used by the solvent coating unit 160 may be the same as a solvent contained in the liquid ink 130′ filled in the pixels 125, that is, a solvent contained in ink ejected from the inkjet head 150.

Subsequently, the solvent coating unit 160 illustrated in FIG. 5 is moved in a lateral direction. Then, while the solvent coating unit 160 is moving in a printing direction (i.e., downward in the drawings) as illustrated in FIG. 6, the solvent coating unit 160 prints printing patterns in the pixels 125.

By repeating the above-described printing process using the inkjet head 150, printing patterns are formed in all the pixels 125 formed on the substrate 110, and the solvent layer 140 is formed to surround the pixels 125 formed on the edge of the substrate 110.

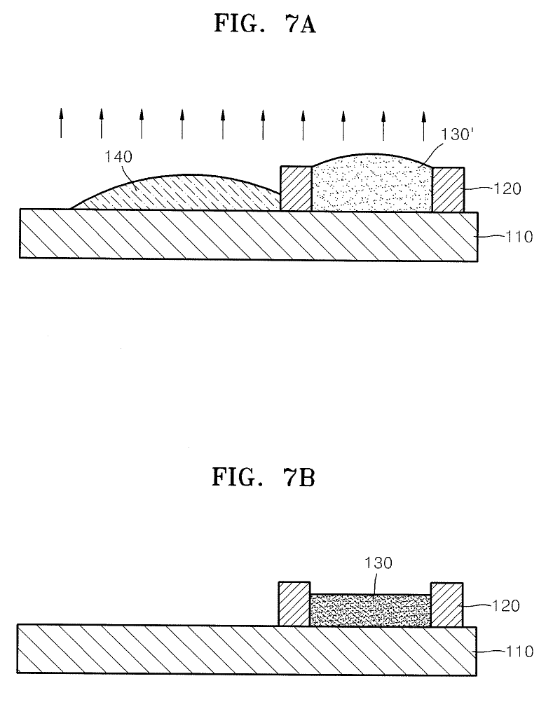

FIG. 7A illustrates a cross-sectional view taken along line VII-VII′ of FIG. 6.

Referring to FIG. 7A, the pixels 125 formed on the edge of the substrate 125 are filled with the liquid ink 130′ ejected from the inkjet head 150, and the solvent layer 140 is formed on the substrate 110 outside the pixels 125 using the solvent coating unit 160. When the solvent layer 140 is formed to surround the pixels 125 located on the edge of the substrate 110 as described above, a solvent atmosphere formed around the pixels 125 located on the edge of the substrate 110 becomes almost the same as a solvent atmosphere formed around the pixels 125 located on the center of the substrate 110. Specifically, while a solvent contained in the ink 130′ filled in the pixels 125 is evaporating, the solvent layer 140 outside the pixels 125 located on the edge of the substrate 110 is evaporating at the same time. Therefore, when drying the ink 130′, a partial pressure of solvent vapors formed around the pixels 125 located on the edge of the substrate 110 becomes almost the same as a partial pressure of solvent vapors formed around the pixels 125 located on the center of the substrate 110. Thus, all the pixels 125 formed on the substrate 110 are in a uniform solvent atmosphere during the drying of the ink 130′. As a result, after the drying of the ink 130′ is finished, a ink layer 130 having a uniform thickness is formed in the pixels 125 located on the edge of the substrate 110 as illustrated in FIG. 7B. Also, the solvent layer 140 formed outside the pixels 125 evaporates and disappears. As described above, by forming the solvent layer 140 to surround the pixels 125 formed on the edge of the substrate 110, the uniform ink layer 130 having a uniform thickness can be formed in all the pixels 125 formed on the substrate 110.

Although the above apparatus for and method of fabricating a color filter have been described in relation to liquid crystal displays (LCDs), the present general inventive concept is not limited thereto and the above apparatus for and method can be used to form an organic emission layer using an inkjet technique during the fabrication of an organic light emitting diode (OLED) or form an organic semiconductor layer using an inkjet technique during the fabrication of an organic thin film transistor (OTFT). In other words, the present general inventive concept can be applied to an apparatus for and method of repetitively printing patterns on a substrate using an inkjet printing technique. Each of the printing patterns can be formed by ejecting a predetermined number of droplets of ink from an inkjet head. According to the present general inventive concept, by coating a solvent on a substrate to surround the printing patterns formed on an edge of the substrate, all the printing patterns formed on the substrate can dry in a uniform solvent atmosphere. Thus, all the printing patterns printed on the substrate can have a uniform thickness after drying the ink.

According to the present general inventive concept, a solvent is coated to surround printing patterns located on an edge of a substrate so that all the printing patterns formed on the substrate can dry in a uniform solvent atmosphere. Therefore, after drying ink, the printing patterns can be formed to a uniform thickness, thereby improving the uniformity of light emitted from respective pixels of a display device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to print printing patterns on a substrate using an inkjet technique, the apparatus comprising:
an inkjet head to eject ink on the substrate to form the printing patterns; and
a solvent coating unit disposed on at least one side of the inkjet head to uniformize a solvent atmosphere formed around the printing patterns during a drying of the ink, the solvent coating unit to coat a solvent layer on the substrate to surround the printing patterns formed on an edge of the substrate.

2. The apparatus of claim 1, wherein the solvent layer coated by the solvent coating unit comprises a same solvent as a solvent contained in the ink used to form the printing patterns.

3. The apparatus of claim 1, wherein the solvent layer formed on the substrate has a width at least twice a length of the printing pattern.

4. The apparatus of claim 3, wherein the solvent layer has a width at least ten times a length of the printing pattern.

5. The apparatus of claim 1, wherein the solvent layer is coated while the inkjet head is printing the printing patterns on the edge of the substrate.

6. The apparatus of claim 1, wherein the solvent coating unit is installed on at least one side of the inkjet head to be capable of moving vertically.

7. The apparatus of claim 1, wherein the inkjet head is one of a piezoelectric inkjet head and a thermal inkjet head.

8. A method of printing patterns by ejecting ink on a substrate using an inkjet printing technique, the method comprising:
coating a solvent layer on the substrate to surround printing patterns printed on an edge of the substrate to uniformize a solvent atmosphere formed around the printing patterns during a drying of the ink.

9. The method of claim 8, wherein the solvent layer coated on the substrate comprises a same solvent as a solvent contained in the ink used to form the printing patterns.

10. The method of claim 8, wherein the solvent layer formed on the substrate has a width at least twice the length of the printing pattern.

11. The method of claim 8, wherein the solvent layer is coated while the inkjet head is printing the printing patterns on the edge of the substrate.

12. An apparatus to fabricate a color filter by ejecting ink in pixels formed on a substrate using an inkjet technique, the apparatus comprising:
an inkjet head to eject the ink in the pixels; and
a solvent coating unit disposed on at least one side of the inkjet head to uniformize a solvent atmosphere formed around the pixels in which the ink is ejected during the drying of the ink, the solvent coating unit to coat a solvent layer on the substrate to surround the pixels formed on an edge of the substrate.

13. The apparatus of claim 12, wherein the solvent layer coated by the solvent coating unit comprises a same solvent as a solvent contained in the ink filled in the pixels.

14. The apparatus of claim 12, wherein the solvent layer formed on the substrate has a width at least twice a length of the pixel.

15. The apparatus of claim 12, wherein the solvent layer is coated while the inkjet head is ejecting the ink in the pixels formed on the edge of the substrate.

16. The apparatus of claim 12, wherein the solvent coating unit is installed on at least one side of the inkjet head to be capable of moving vertically.

17. A method of fabricating a color filter by ejecting ink in pixels formed on a substrate using an inkjet printing technique, the method comprising:
coating a solvent layer on the substrate to surround pixels formed on an edge of the substrate to uniformize a solvent atmosphere formed around the pixels in which the ink is ejected during a drying of the ink.

18. The method of claim 17, wherein the solvent layer coated on the substrate comprises a same solvent as a solvent contained in the ink ejected to form the pixels.

19. The method of claim 17, wherein the solvent layer formed on the substrate has a width at least twice the length of the pixel.

20. The method of claim 17, wherein the solvent layer is coated while the inkjet head is ejecting the ink in the pixels formed on the edge of the substrate.

21. A printing apparatus usable in color filter fabrication, the printing apparatus comprising:
an inkjet printhead to eject ink into a plurality of pixels defined in the color filter; and
a solvent coating unit to coat a solvent layer around the color filter.

22. The printing apparatus of claim 21, wherein the solvent layer surrounds the color filter such that a solvent atmosphere of the pixels at a periphery of the color filter is substantially uniform to a solvent atmosphere of the pixels at a center of the color filter during drying of the ink.

23. The printing apparatus of claim 21, wherein the solvent layer comprises a same solvent as a solvent in the ink.

24. The printing apparatus of claim 21, wherein the solvent layer has a width at least twice a length of a pixel.

25. The printing apparatus of claim 21, wherein the solvent coating unit is disposed on at least one side of the inkjet printhead, such that the solvent layer is coated during the ink ejection process.
